(19) United States
(12) Patent Application Publication
(10) Pub. No.: US 2025/0253315 A1
(43) Pub. Date: Aug. 7, 2025

(54) CARBON NANOSTRUCTURES FOR ELECTRODES

(71) Applicant: Alliance for Sustainable Energy, LLC, Golden, CO (US)

(72) Inventors: Nathan Richard NEALE, Denver, CO (US); Gerard Zachary CARROLL, Littleton, CO (US); Jae Ho KIM, Lakewood, CO (US)

(21) Appl. No.: 19/044,372

(22) Filed: Feb. 3, 2025

Related U.S. Application Data
(60) Provisional application No. 63/549,115, filed on Feb. 2, 2024.

(51) Int. Cl. H01M 4/36; H01M 4/02; H01M 4/133; H01M 4/38; H01M 4/587; H01M 4/62

(52) U.S. Cl. CPC H01M 4/364; H01M 4/133; H01M 4/386; H01M 4/587; H01M 4/623; H01M 4/625; H01M 2004/021

(57) ABSTRACT

The present disclosure relates to a mixture having a porosity between 15% and 75% empty volume and including a plurality of silicon particles, at least one of a first carbonaceous material, a second carbonaceous material, a third carbonaceous material, or a combination thereof, where the first carbonaceous material has a first aspect ratio (AR₁) where ˜1≤AR₁<2, the second carbonaceous material has a second aspect ratio (AR₂) where 2≤AR₂<100, and the third carbonaceous material has a third aspect ratio (AR₃) where AR₃≥100.

### CROSS-REFERENCE TO RELATED APPLICATIONS

This application claims priority from U.S. Provisional Patent Application No. 63/549,115 filed on Feb. 2, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Carbon additives in lithium-ion battery electrodes are needed to provide electrical conductivity through the electrode but can also have a strong influence on the electrode morphology that dictates ion transport. Both electron and ion transport properties are key parameters determining cycling performance of lithium-ion batteries. However, carbonaceous additive combinations for silicon nanoparticle-based composite electrodes that provide performance metrics suitable for large-scale introduction into the marketplace have not yet been identified. Thus, there remains a need in the field of lithium-ion batteries, as well as in other fields and applications (e.g., catalysis), for improved mixtures and compositions that enable better performing composite electrodes.

### SUMMARY

An aspect of the present disclosure is a mixture having a porosity between 15% and 75% empty volume and including a plurality of silicon particles, at least one of a first carbonaceous material, a second carbonaceous material, a third carbonaceous material, or a combination thereof, where the first carbonaceous material has a first aspect ratio (AR₁) where ˜1≤AR₁<2, the second carbonaceous material has a second aspect ratio (AR₂) where 2≤AR₂<100, the third carbonaceous material has a third aspect ratio (AR₃) where AR₃≥100, and the silicon particles are present in the mixture at a first concentration between 1 wt % and 50 wt %. In some embodiments of the present disclosure, the second carbonaceous and the third carbonaceous may be present at a first weight ratio between 1:20 and 20:11.

In some embodiments of the present disclosure, the first carbonaceous material may include at least one of carbon black, carbon nanoparticles, or a combination thereof. In some embodiments of the present disclosure, the second carbonaceous material may include at least one of a carbon nanorod, a carbon nanofiber, or a combination thereof. In some embodiments of the present disclosure, the third carbonaceous material may include at least one of a single-walled carbon nanotube, a multi-walled carbon nanotube, a branched carbon nanotube, or a combination thereof.

In some embodiments of the present disclosure, a mixture may further include a binder. In some embodiments of the present disclosure, the binder may include at least one of polyimide, polyvinylidene fluoride, polyacrylic acid, carboxymethyl cellulose, or a combination thereof. In some embodiments of the present disclosure, the binder may be present in the mixture at a second concentration between 0.01 wt % and 20 wt %.

In some embodiments of the present disclosure, the silicon may be present in the mixture at a mass loading between 0.1 mg Si/cm² and 100 mg Si/cm². In some embodiments of the present disclosure, the silicon particles may have an average particle size between 1 nm and 1 μm. In some embodiments of the present disclosure, the first carbonaceous material may have an average diameter between 10 nm and 2 μm. In some embodiments of the present disclosure, the first carbonaceous material may be substantially spherical in shape. In some embodiments of the present disclosure, the second carbonaceous material may have an average width between 10 nm and 500 nm. In some embodiments of the present disclosure, the third carbonaceous material may have an average width between 1 nm and 100 nm.

In some embodiments of the present disclosure, the porosity may include at least one of macropores, mesopores, or micropores, or a combination thereof where the macropores have pores with an average diameter greater than 50 nm, the mesopores have pores with an average diameter between 2 nm and 50 nm, inclusively, and the micropores have pores with an average diameter less than 2 nm. In some embodiments of the present disclosure, the macropores may be between 0 vol % and 100 vol % of the porosity. In some embodiments of the present disclosure, the mesopores may be between 0 vol % and 100 vol % of the porosity. In some embodiments of the present disclosure, the micropores may be between 0 vol % and 100 vol % of the porosity.

In some embodiments of the present disclosure, a mixture may be further characterized by a MacMullan number between 1 and 50. In some embodiments of the present disclosure, a mixture may be further characterized by an electrical resistivity between 1×10⁻¹ Ωcm and 1×10⁹ Ωcm.

An aspect of the present disclosure is an electrode having a mixture that includes a plurality of silicon particles, at least one of a first carbonaceous material, a second carbonaceous material, a third carbonaceous material, or a combination thereof and a current collector having a surface, where the mixture is positioned in the form of a layer on the surface.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a mixture, according to some embodiments of the present disclosure.

FIG. 2 illustrates a schematic illustration of nanosized silicon electrodes with different carbonaceous materials, according to some embodiments of the present disclosure.

FIG. 3 illustrates morphology and electrochemical characterization of carbonaceous-PI electrodes, according to some embodiments of the present disclosure. (A-C) SEM images of (A) carbon black (CB), (B) carbon nanorods (CNRs), and (C) carbon nanotubes (CNTs). (D-F) scanning electron microscopy (SEM) images of the carbonaceous-PI electrodes for (D) CB, (E) CNR, and (F) CNT. (G) Specific capacities of the carbonaceous-polyimide (PI) electrodes. (H and I) voltage profiles at (H) 50 mA g⁻¹ and (I) 300 mA g⁻¹.

FIG. 4 illustrates high magnification SEM images of (A) CB, (B) CNRs, and (C) CNTs, according to some embodiments of the present disclosure.

FIG. 5 illustrates high magnification SEM images of carbonaceous-PI electrodes for (A) CB, (B) CNRs, and (C) CNTs, according to some embodiments of the present disclosure.

FIG. 6 illustrates Coulombic efficiency of the carbonaceous-PI electrodes, according to some embodiments of the present disclosure.

FIG. 7 illustrates electron and ion transport properties of Si/carbonaceous electrodes, according to some embodiments of the present disclosure. (A-C) SEM images of the nanosized Si electrodes with (A) CB, (B) CNRs, and (C) CNTs. (D-F) Electrode surface maps of SSRM for (D) the Si/CB, (E) Si/CNR, and (F) Si/CNT electrodes. (G) Cyclic voltammetry curves for the Si/CNR electrode at different scan rates within the voltage range of −0.1-0.1 V (vs. OCV). (H) Current at open circuit voltage as a function of the scan rate. (I) Magnified Nyquist plots of symmetric cells of the nanosized Si electrodes with different carbonaceous materials.

FIG. 8 illustrates low magnification SEM images of the nanosized silicon electrodes with (A) CB, (B) CNRs, and (C) CNTs, according to some embodiments of the present disclosure.

FIG. 9 illustrates SSRM electrode surface resistivity maps for (A) the Si/CB, (B) Si/CNRs, and (C) Si/CNTs electrodes, according to some embodiments of the present disclosure.

FIG. 10 illustrates resistivity distribution histograms of (A) the Si/CB, (B) Si/CNRs, and (C) Si/CNTs electrodes at multiple 5 μm by 5 μm sites, according to some embodiments of the present disclosure.

FIG. 11 illustrates CV curves for (A) the Si/CB and (B) Si/CNTs electrodes at different scan rates within the voltage range of −0.1-0.1 V (vs. OCV), according to some embodiments of the present disclosure.

FIG. 12 illustrates Nyquist plots of symmetric cells of the nanosized Si electrodes with different carbonaceous materials, according to some embodiments of the present disclosure.

FIG. 13 illustrates correlations between electrochemical parameters and electron/ion transport properties of Si/carbonaceous electrodes, according to some embodiments of the present disclosure. (A) Lithiation/delithiation voltage profile of the Si/CNRs electrode in a half cell configuration for the first three cycles at C/20. (B) The silicon utilization as a function of electrode mass loading; (C) Theoretical specific capacity (y-axis intercept of FIG. 15); and (D) slope of FIG. 4B (Si utilization vs. mass loading) correlated with electron transport behavior (log(Electrical resistivity)) and ion transport behavior (MacMullin number).

FIG. 14 illustrates lithiation/delithiation voltage profiles of (A) the Si/CB and (B) Si/CNTs electrodes, according to some embodiments of the present disclosure.

FIG. 15 illustrates (A) specific capacity and (B) cumulative Coulombic efficiency of the nanosized silicon electrodes with different carbonaceous materials as a function of electrode mass loading, according to some embodiments of the present disclosure.

FIG. 16 illustrates a characterization of nanosized silicon electrodes with blended 1D carbonaceous materials, according to some embodiments of the present disclosure. (A) SEM image of the Si/RT14 electrode. (B) Electrode surface map of SSRM for the Si/RT14 electrode. (C) MacMullin number and electrochemical double layer capacitance of the electrodes as a function of porosity. (D) Lithiation/delithiation voltage profile of the Si/RT14 electrode in a half cell configuration for the first three cycles at C/20. (E and F) Electrochemical parameters after the 3^{rd} formation cycle as a function of electrode mass loading for (E) Si utilization and (F) Cumulative Coulombic efficiency. (G) Charge/discharge voltage profiles at C/10 of the Si/RT14 full cell. (H) Discharge ASI of the full cells at different voltages. (I) Cycle data of the prelithiated full cells.

FIG. 17 illustrates low magnification SEM images of the Si/RT14 electrode, according to some embodiments of the present disclosure.

FIG. 18 illustrates electrode surface maps of SSRM for the Si/RT14 electrode, according to some embodiments of the present disclosure.

FIG. 19 illustrates a resistivity distribution histogram of the Si/RT14 electrode, according to some embodiments of the present disclosure.

FIG. 20 illustrates CV curves for the Si/RT14 electrode at different scan rates within the voltage range between −0.1 V and 0.1 V (vs. OCV), according to some embodiments of the present disclosure.

FIG. 21 illustrates magnified Nyquist plots of symmetric cells of the Si/RT14 electrode, according to some embodiments of the present disclosure.

FIG. 22 illustrates specific capacity of the Si/CNT and Si/RT14 electrodes as a function of electrode mass loading, according to some embodiments of the present disclosure.

FIG. 23 illustrates lithiation/delithiation voltage profiles of (A) the Si/RT14 and (B) Si/CNT half-cell during the formation cycles, according to some embodiments of the present disclosure.

FIG. 24 illustrates charge/discharge voltage profiles at C/10 of the Si/CNT full cell, according to some embodiments of the present disclosure.

FIG. 25 illustrates HPPC profile of (A) the Si/RT and (B) Si/CNT full cell (inset: magnified HPPC profile), according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### REFERENCE NUMERALS

100 . . . mixture
110 . . . silicon particle
120 . . . first carbonaceous material
122 . . . second carbonaceous material
124 . . . third carbonaceous material

### DETAILED DESCRIPTION

The present disclosure relates to the use of one or more carbonaceous materials to improve the electronic conductivity and ionic conductivity of composite electrodes. In some embodiments of the present disclosure, an electrode may be based on silicon nanoparticles (Si NPs) and the electrode may be used in a lithium-ion battery (LIB). However, the concepts described herein may have much broader applications beyond just Si NP-based anodes for LIBs and potentially be used to enhance the properties in electrodes made of different materials for other applications, such as in electrochemical catalysis (e.g., gas diffusion electrodes), different ion batteries (Na⁺, Mg²⁺, etc.), electrochemical capacitors, electrochemical intercalation devices, or redox flow batteries.

Intrinsic Si NP anodes have low inherent electronic and ionic conductivity that can limit their performance in LIBs. A good electronic conducting network is important to ensure all portions of three-dimensional (3D) electrode films have access to electrons. Similarly, it is essential to have sufficient porosity in electrodes to enable macroscopic Li-ion transport via the liquid electrolyte that fills the pores, e.g., spaces between Si NPs. The present disclosure describes a method to independently tailor the electrical and ionic conducting compositions contained in Si NP-containing anodes, thereby greatly improving the specific energy and energy density of the resultant LIBs.

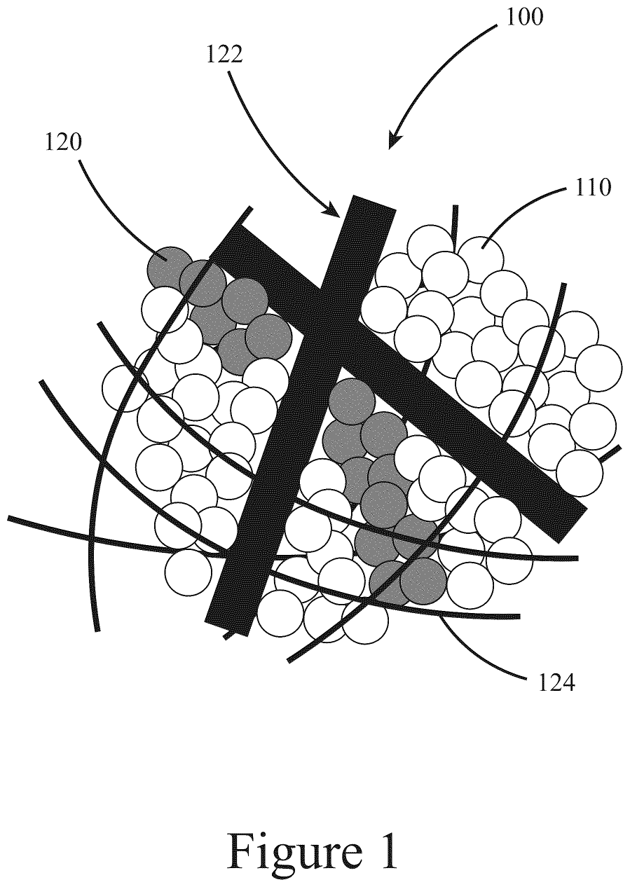

FIG. 1 illustrates a composition and/or mixture 100 (referred to herein simply as a mixture for simplicity), according to some embodiments of the present disclosure. As described above, in some embodiments of the present disclosure, such a mixture 100 may be used to construct Si NP-based anodes for LIBs. Such a mixture 100 may include a plurality of silicon particles 110 (e.g., Si NPs) and at least one carbonaceous material to provide electrical conductivity. In some embodiments of the present disclosure, a silicon particle 110 may have a shape that is substantially spherical and/or oblong. In some embodiments of the present disclosure, a silicon particle 110 may have an average particle diameter and/or characteristic length between 1 nm and 1 μm or between 3 nm and 150 nm (diameter applies to spherical particles; characteristic length applies to other shapes and may be an average length or width, a maximum length or width, etc., depending on the shape). As defined herein, silicon nanoparticles (Si NPs) have length dimension between 3 nm and 150 nm. In some embodiments of the present disclosure, silicon particles 110 may be present in a mixture 100 at a first concentration between 1 wt % and 50 wt % or between 10 wt % and 35 wt %. Silicon particles 110 may further include at least one element in addition to silicon, for example at least one of boron, aluminum, gallium, indium, phosphorous, and/or arsenic. In some embodiments of the present disclosure, the amount of silicon present in a mixture 100, as provided by the silicon nanoparticles 110, may result in a mass loading between 0.1 mg Si/cm² and 100 mg Si/cm², or between 1 mg Si/cm² and 10 mg Si/cm², or between 1 mg Si/cm² and 5 mg Si/cm², inclusively. (Basis: mass of silicon per unit surface area of the current collector that the composite electrode is deposited onto as provided by the entire mixture (silicon+carbonaceous materials+binder)).

Referring again to FIG. 1, a mixture 100 may include at least one carbonaceous material, or two or more carbonaceous materials, where the different materials are characterized by different dimensions such as length and width. As used herein, “aspect ratio” is defined as the ratio of a length to a width. In some embodiments of the present disclosure, a mixture 100 may include a first carbonaceous material 120 having a first aspect ratio (AR₁) where ˜1≤AR₁<2. An example of a first carbonaceous material 120 is carbon black. In some embodiments of the present disclosure, a mixture 100 may include a second carbonaceous material 122 having a second aspect ratio (AR₂) where 2≤AR₂<100. Examples of a second carbonaceous material 122 include carbon nanorods and carbon nanofiber. In some embodiments of the present disclosure, a mixture 100 may include a third carbonaceous material 124 having a third aspect ratio (AR₃) where AR₃≥100. Examples of a third carbonaceous material 124 include single-walled carbon nanotubes, multi-walled carbon nanotubes, and branched carbon nanotubes. In some embodiments of the present disclosure, a mixture 100 may include other carbonaceous materials characterized by other aspect ratios. In some embodiments of the present disclosure, a mixture 100 may include only one carbonaceous material, only two carbonaceous materials, only three carbonaceous materials, or more than three carbonaceous materials, where each carbonaceous material is characterized at least by a different aspect ratio or range of aspect ratios.

In some embodiments of the present disclosure, a first carbonaceous material 120 and a second carbonaceous material 122 may be present at a first weight ratio between 1:20 and 20:1 or between 1:10 and 1:1. In some embodiments of the present disclosure, a second carbonaceous material 122 and a third carbonaceous material 124 may be present at a second weight ratio between 1:20 and 20:1 or between 1:10 and 1:1. In some embodiments of the present disclosure, a first carbonaceous material 120 and a second carbonaceous material 122 may be present at a first weight ratio between 1:20 and 20:1 or between 1:10 and 1:1. In some embodiments of the present disclosure, a first carbonaceous material 120 and a third carbonaceous material 124 may be present at a third weight ratio between 1:20 and 20:1 or between 1:10 and 1:1.

In some embodiments of the present disclosure, a first carbonaceous material may be substantially spherical in shape with an average diameter between 10 nm and 2 μm or between 30 and 100 nm. A second carbonaceous material may have an average width between 10 nm and 500 nm or between 50 nm and 200 nm. A third carbonaceous material may have an average width between 1 nm and 100 nm or between 10 nm and 50 nm and/or an average length between 10 nm and 10 μm or between 100 nm and 1 μm. In some embodiments of the present disclosure, a first carbonaceous material may be substantially spherical in shape with an average diameter between 10 nm and 2 μm or between 30 and 100 nm and a first aspect ratio ˜1≤AR₁<2. A second carbonaceous material may have an average width between 10 nm and 500 nm or between 50 nm and 200 nm and a second aspect ratio 2≤AR₂<100. A third carbonaceous material may have an average width between 1 nm and 100 nm or between 10 nm and 50 nm and/or an average length between 10 nm and 10 μm or between 100 nm and 1 μm and a third aspect ratio AR₃≥100.

In some embodiments of the present disclosure, a mixture 100 may also include a binder (not shown in FIG. 1). Examples of binders include polyimide (PI), polyvinylidene fluoride (PVDF), polyacrylic acid (PAA), carboxymethyl cellulose (CMC). A binder may be present in a mixture 100 at a concentration between 0.01 wt % and 50 wt % or between 1 wt % and 20 wt % (relative to the mass of carbonaceous materials and binder). However, a binder is not required; e.g., a mixture 100 may be “binderless”.

As described in more detail below, the porosity (not shown in FIG. 1) of a mixture 100 may be tuned to a specific value and/or range by adjusting the relative amounts of the carbonaceous materials being used. Further, by adjusting the porosity, the ionic conductivity of a mixture 100 may also be adjusted. In some embodiments of the present disclosure, a porosity of a mixture 100 may be between 15% and 75% or between 25% and 50% (as volume percentages). This porosity may be visualized as a volume filled with the ambient gas or as a volume that is at least partially filled by a liquid electrolyte.

A porosity of a mixture 100 may include at least one of macropores, mesopores, and/or micropores. As defined herein, macropores are pores having an average diameter greater than 50 nm, mesopores are pores having an average diameter between 2 nm and 50 nm, inclusively, and micropores are pores having an average diameter less than 2 nm. In some embodiment of the present disclosure, macropores contributing to a porosity of a mixture 100 may be between 0 vol % and 100 vol %, inclusively or between 15 vol % and 60 vol %. In some embodiment of the present disclosure, mesopores contributing to a porosity of a mixture 100 may be between 0 vol % and 100 vol %, inclusively or between 15 vol % and 60 vol %. In some embodiments of the present disclosure, micropores contributing to a porosity of a mixture 100 may be between 0 vol % and 100 vol %, inclusively or between 15 vol % and 60 vol %.

A mixture 100 may be characterized by performance metrics, such as silicon utilization (the amount of silicon that is participating in lithium ion exchange), MacMullin number, and/or electrical resistivity. In some embodiments of the present disclosure, a mixture 100 may have a silicon utilization between greater than 0% and 100%, or between 25% and 99%, or between 60% and 80%, inclusively. In some embodiments of the present disclosure, a mixture 100 may be characterized by a MacMullin number between 1 and 50 or between 1.5 and 20. In some embodiments of the present disclosure, a mixture 100 may have an electrical resistivity between 1×10⁻⁴ Ωcm and 1×10⁹ Ωcm or between 1×10⁻² Ωcm and 1×10⁴ Ωcm.

Mixtures 100 like that illustrated in FIG. 1, and as described above, may be used to produce, among other things, electrodes having sufficient porosity to enable both electrical transport and ionic transport through the mixture 100. In some embodiments of the present disclosure, an electrode may be constructed that includes a current collector with mixtures like those described, where the mixtures are positioned on at least one surface of the current collector. A current collector may be constructed of a metal, for example, at least one of copper, silver, gold, titanium, nickel and/or aluminum or non-metal, for example hard carbon and/or carbon nanotube and/or fiber mats. A mixture 100 may be applied to a surface of a current collector to form a layer having a thickness between 1 nm and 0.5 mm or 1 μm and 100 μm. Such an electrode may then be positioned in a battery. In some embodiments of the present disclosure, an electrode using carbonaceous compositions like those described herein may be in contact with a separator such as a polymer consisting of polyethylene, polypropylene, cellulose, polyamide, poly(tetrafluoroethylene), poly(vinyl chloride). One industrial material used for a separator and tested herein is Celgard®.

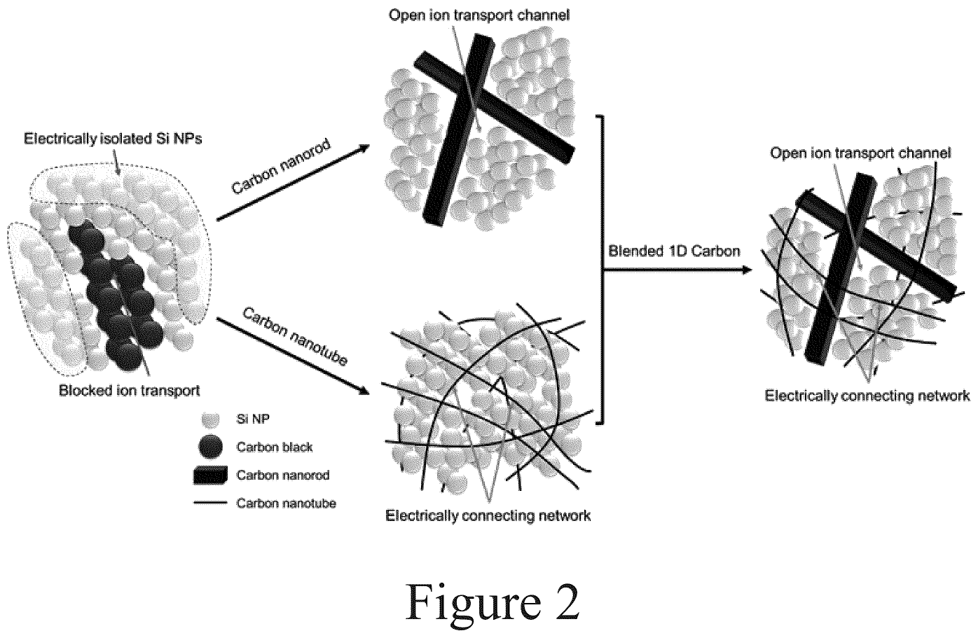

The morphology of a composite electrode dictates important parameters like porosity, pore size dimension, ionic transport, component dispersion, and/or electrical conductivity. Any solid material in a composite electrode contributes to the overall electrode morphology. When the active material has a diameter on the same order as zero-dimensional (0D) carbon black particles, the dense packing between these two materials can result in more electrically isolated Si particles (see left panel in FIG. 2). Further, dense packed morphologies create highly tortuous nanoscale pore channels that inhibit mass transport. Described herein is a systematic investigation of the electron transport and ion transport behavior of nanosized Si-based electrodes with carbon nanostructures that have different aspect ratios. It is shown herein that the carbonaceous materials with different aspect ratios can be used to independently tune electronic and ionic conductivities in composite anodes (see center panels in FIG. 2). Furthermore, it is shown herein that different carbon additives that improve either electronic or ionic transport can be combined into a single electrode and have a cumulative positive impact on both ionic and electronic conductivity. (see right panel in FIG. 2). These insights allow a new, scalable strategy for simultaneously improving electron transport and ion transport by careful, selective engineering of the carbonaceous additives.

The following describes the impact of combining carbonaceous materials having different aspect ratios on the electron transport and ion transport properties in silicon nanoparticle-based composite electrodes. The results show that combining carbon nanostructures having a range of aspect ratios can provide a platform to decouple electron and ion transport and optimize each property separately. Furthermore, it is shown herein that combining different carbon nanostructures in a single composite provides a cumulative improvement in both ionic and electronic conductivity. This promising electrode architecture strategy may be especially useful in high-capacity electrodes with mass loadings >1.5 mg cm⁻².

### Morphology and Electrochemical Characterization of Carbon-PI Electrodes:

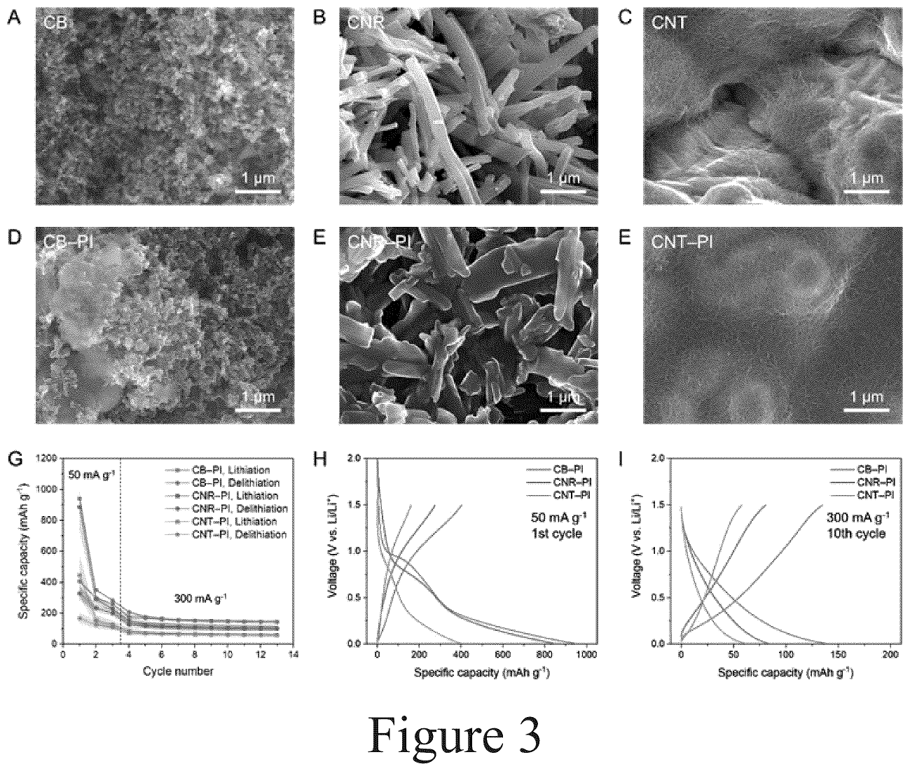

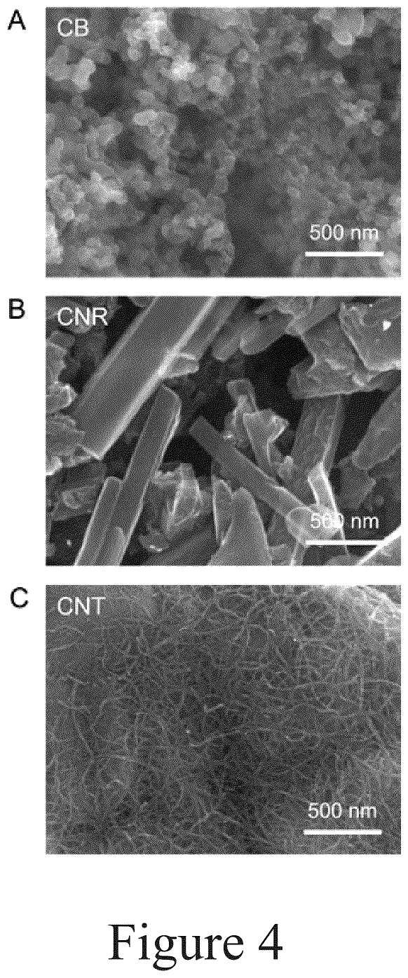

Three carbon nanostructures, carbon black (CB), i.e., an example of a first carbonaceous material, carbon nanorods (CNR), i.e., an example of a second carbonaceous material, and multiwalled carbon nanotubes (CNT), i.e., an example of a third carbonaceous material, were selected based on their aspect ratios. Carbon morphologies of the three carbonaceous materials used in this study are shown in the SEM images in Panels A-C of FIGS. 3 and 4. Carbon black typically has a quasi-spherical particle shape (aspect ratio: ˜1) with diameters between 100 and 200 nm. In contrast, the carbon nanorods are anisotropic with average dimensions on the order of 300 nm wide and 2.5 μm long, resulting in an aspect ratio of about 8. Carbon nanotubes typically have a string-like morphology with high aspect ratios ranging from 100 to 500, that when drop cast onto an SEM substrate, stack together to form a mat-like structure.

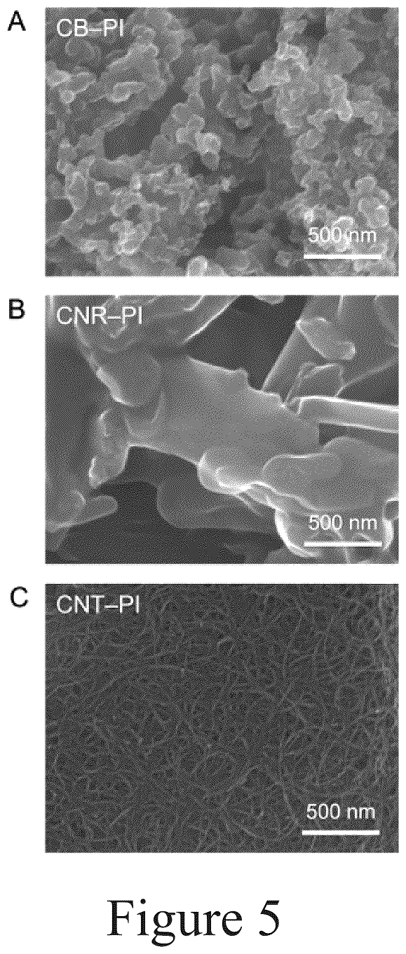

To probe the stand-alone electrochemical properties of these different carbonaceous materials, electrodes were prepared having only carbon and a binder on a copper current collector. A polyimide (PI) binder was used for its strong adhesive and mechanical properties that eliminate electrode delamination and structural collapse during lithiation/delithiation. Following the coating and drying process, the electrodes were cured at 450° C. in nitrogen to induce PI crosslinking, ensuring robust adhesion. SEM images of the carbon-PI electrodes (referred to simply as ‘carbon-PI’ hereafter for simplicity) reveal morphologies like those of their underlying carbon nanostructure sources, but with a loss of definition from the presence of the PI binder (see Panels D-F of FIGS. 3 and 5). Notably, the CB-PI electrode displayed clear segregation between the carbon and the PI indicating a poor dispersion.

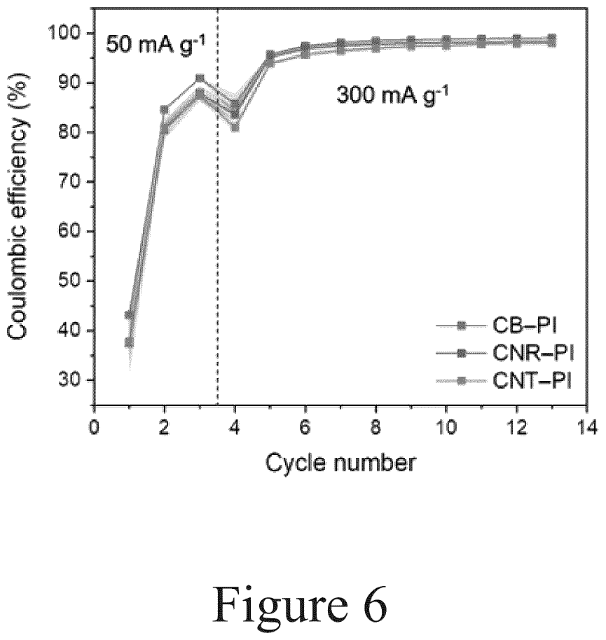

The specific capacity and voltage profile for each carbon electrode in a half cell configuration is shown in Panels G-I of FIG. 3 and FIG. 6. All electrodes were assembled with a lithium metal counter electrode in a half cell configuration with 1.2M LiPF₆ in 3:7 ethylene carbonate: ethylmethyl carbonate with 3 wt. % fluoroethylene carbonate (GenF) electrolyte. CB-PI and CNR-PI electrodes exhibited first cycle irreversible capacities of 535.3 and 557.5 mAh g⁻¹, respectively, significantly larger than the CNT-PI electrode (280.9 mAh g⁻¹). The voltage profiles show that the sloped plateau associated with solid electrolyte interphase (SEI) formation (0.7-1.0 V) is more pronounced in the CB-PI electrode and CNR-PI electrode compared to the CNT-PI electrode, consistent with the lower first cycle Coulombic efficiency (CE) compared to the CNT-PI electrode (see Panel H of FIG. 3). Below 0.5 V, the capacity originates from lithium storage in nanopores and doping/dedoping of the PI binder. This lower irreversible capacity in the first cycle is presumably attributed to the formation of a dense network between carbon nanotubes and PI binder. At a current density of 300 mA g⁻¹, all three electrodes maintained a consistent capacity of 141.8, 99.7, and 57.6 mAh g⁻¹ for CB-PI, CNR-PI, and CNT-PI, respectively (see Panel I of FIG. 3). In addition, all three carbon-PI electrodes exhibited a sloping line voltage profile without a distinct plateau, suggesting that the predominant capacity can be attributed to capacitive charge storage of carbon combined with redox activity of lithiating/delthiating PI at higher current density (see Panel I of FIG. 3). By performing these electrochemical tests, one can attribute the contribution of carbon and PI to the Li storage and non-Coulombic properties of the different carbons.

Study on Electron and Ion Transport Properties of Nanosized Si Electrodes with Different Carbon:

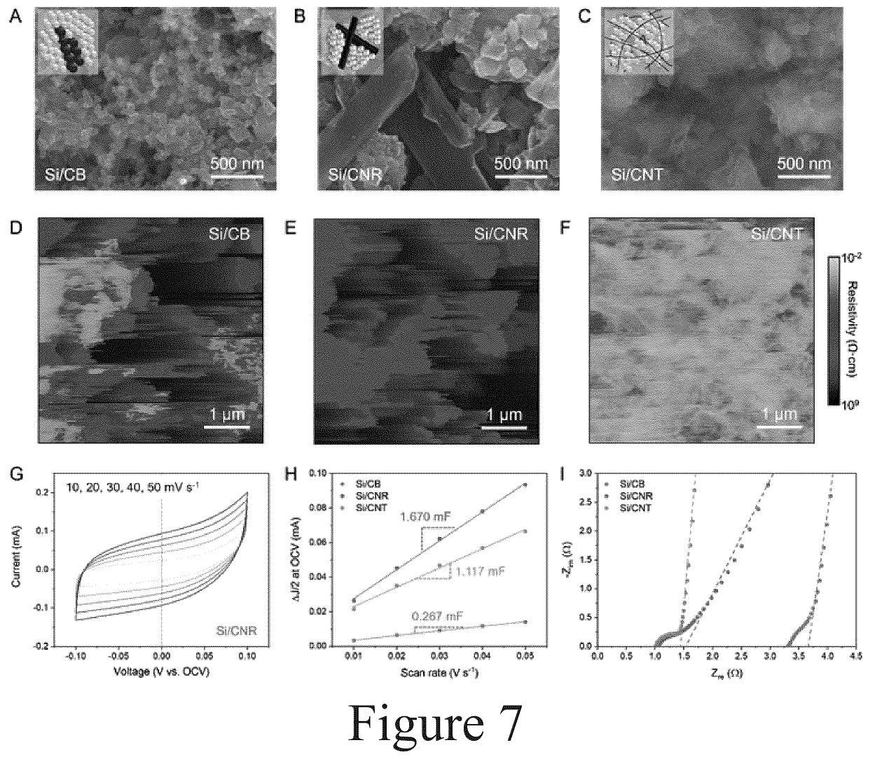

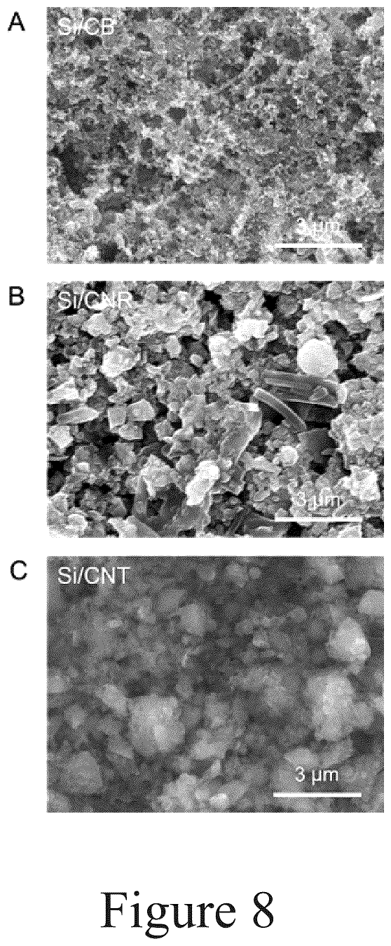

Next, composite electrodes were prepared containing boron-doped milled silicon particles (diameter between 100 nm and 200 nm) with three types of carbonaceous materials and PI binder (denoted as Si/Carbon, where “Carbon” refers to at least one of CB, CNRs, and/or CNTs). SEM of these electrodes is displayed in Panels A-C of FIG. 7 and FIG. 8. The Si/CB electrode has a dense and random arrangement of nanosized silicon that resembles the morphology of the CB-PI electrode described above. In contrast, Si/CNR electrode has visible macropores (>50 nm diameter) throughout the volume of the electrode. The Si/CNT electrode demonstrates a morphology of a closely packed aggregated structure with CNTs dispersed throughout the volume. From the measured volume and the known density of the electrode contents, the porosity of Si/CB, Si/CNR, and Si/CNT electrodes are estimated to be 34%, 54%, and 44%, respectively.

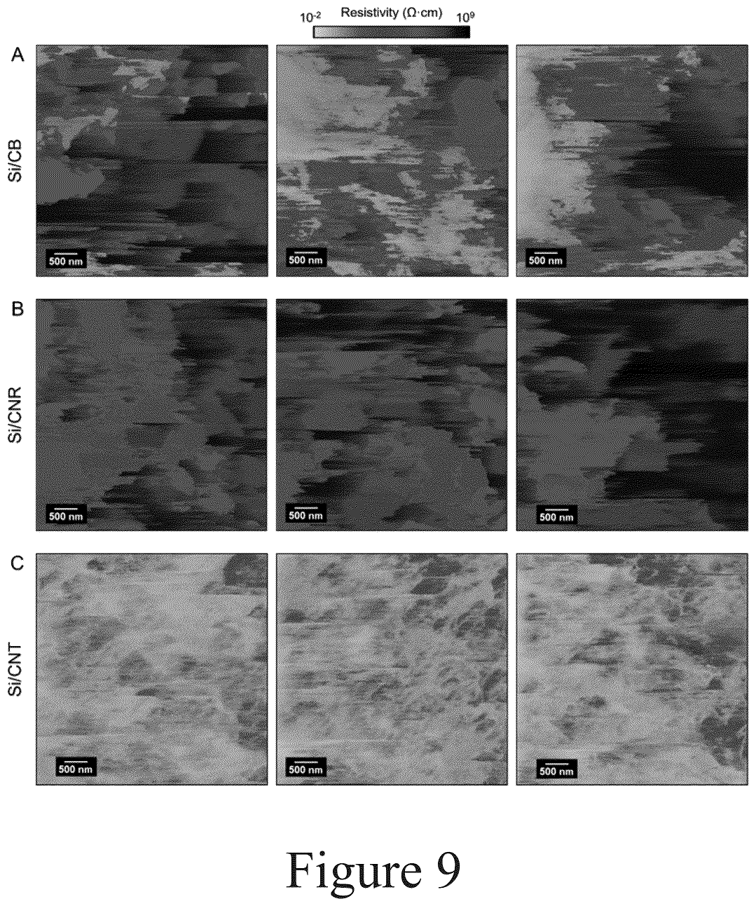

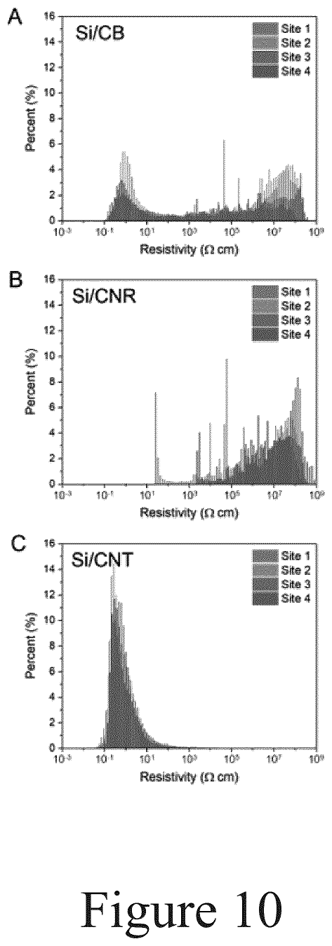

To understand how the different carbonaceous materials impact the electrical connectivity, scanning spreading resistance microscopy (SSRM) mapping was performed on the silicon composite electrodes. SSRM maps were collected by scanning a 5 μm×5 μm area of the composite electrode and the data are displayed in Panel D-F of FIG. 7 and FIG. 9. The resistance map of the Si/CB electrode shows a highly heterogeneous distribution of resistivity values across the electrode, with low resistivity domains of CB-aggregates and high resistivity PI-aggregates. Binning the resistivity values to create a histogram shows a clear bimodal distribution; consistent with a poor dispersion in Si/CB (see Panel A of FIG. 10). The SSRM map of the Si/CNR electrode displays a more homogeneous, but higher average resistivity of 4.02×10⁶ Ω·cm indicating a poor conduction network (see Panel B of FIG. 10). Si/CNT, however, is both homogeneous and highly conductive with average resistivity values of 8.64×10⁻¹ Ω·cm (see FIGS. 9 and 10). Combined with SEM images in Panels A-C of FIG. 7, the SSRM indicates that the choice of carbon has a large impact on an electrode's uniformity and conductivity.

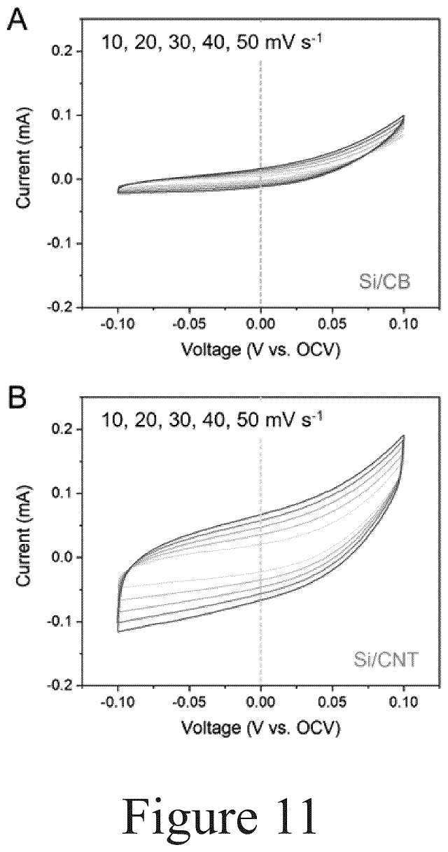

To understand how the different carbonaceous materials influence the electrochemically active surface area (ECSA) of Si-based electrodes, cyclic voltammetry (CV) measurements were gathered in a three-electrode cell using the electrodes with same mass loading (1.5 mg cm²) under electrolyte ion blocking conditions with tetrabutylammonium hexafluorophosphate (TBAPF₆) as the salt. The data are shown in Panel G of FIG. 7 and FIG. 11. The CV is a quasi-rectangular shape with no redox features indicating the current is due to double layer charging only. Current values at open circuit voltage were collected and plotted as a function of scan rate. Electrochemical double layer capacitance values (EDLC) were derived from the slopes of the plots (see Panel H of FIG. 7). Considering that the specific capacitance of silicon is the same for the three electrodes, EDLC values are proportional to the ECSA. When compared to the Si/CB electrode at 0.267 mF, the 1D carbon nanostructures increased the EDLC to 1.117 and 1.670 mF for the Si/CNT electrode and the Si/CNR electrode, respectively. Importantly, the highest EDLC value was obtained from the Si/CNR electrode. The larger EDLC value indicates that CNR improves accessibility of electrolyte to the Si/CNR electrode by increasing the porosity of the electrode to 54%.

To quantify the ion transport properties in these composite Si electrodes, the MacMullin number (N_{M}) was determined by performing electrochemical impedance spectroscopy under ion-blocking conditions. N_{M} is a measure of the influence of an electrode microstructure on the ionic conductivity and is related to the electrode tortuosity. When the effective ionic conductivity (K_{eff}) of the electrode is close to its intrinsic conductivity of the electrolyte (κ), N_{M} approaches 1. N_{M} is calculated using Equation 1 where Rᵢₒₙ is the effective ionic resistance, A is the electrode, and d is the thickness of the electrode.

$${sN}_{M} = \frac{κ}{{κ}_{eff}} = \frac{{R}_{Ion} \cdot A \cdot κ}{d} \qquad Equation 1$$

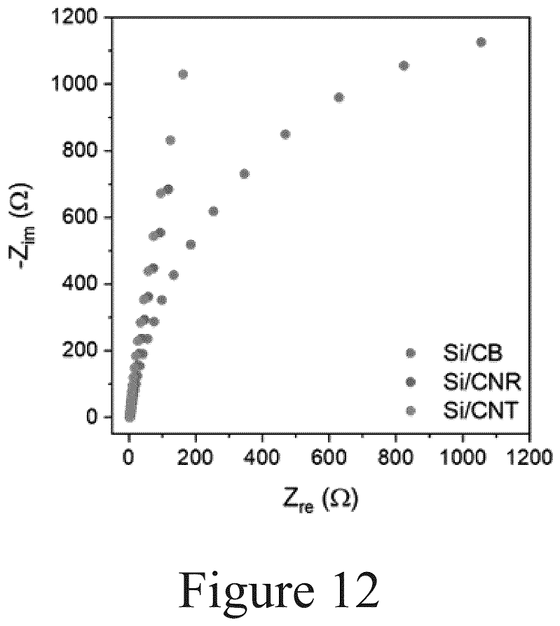

In the Nyquist plots of the Si/Carbon electrodes (see Panel I of FIG. 7, FIG. 12, and Table 1), the Si/CB electrode has a lower slope in the low frequency region compared to the other electrodes. Under ion blocking conditions, this slope is controlled by the ionic diffusion resistance, Rᵢₒₙ. Rᵢₒₙ is determined by a linear extrapolation of the low-frequency line in the magnified Nyquist plots (see dashed lines, Panel I of FIG. 7), and all fitting parameters are summarized in Table 1. From this analysis, the Si/CNR electrode has the lowest N_{M} (15.4), followed by the Si/CNT electrode (16.8) and finally the Si/CB electrode (20.4). This trend is consistent with the EDLC measurements in Panel H of FIG. 7 and clearly shows that the morphology induced by the CNRs provides the best microstructure for ionic transport.

TABLE 1
Parameters for calculation of the MacMullin number.

| | | R_{HFR} + | | | | | |
|---|---|---|---|---|---|---|---|
| | R_{HFR} | Rᵢₒₙ/3 | Rᵢₒₙ* | d | A | kᵢₙₜ | |
| | (Ω) | (Ω) | (Ω) | (cm) | (cm²) | (S cm⁻¹) | N_{M} |
| Si/CB | 3.307 | 3.675 | 0.552 | 0.0010 | 1.539 | 0.024 | 20.4 |
| Si/CNR | 1.054 | 1.500 | 0.669 | 0.0016 | 1.539 | 0.024 | 15.4 |
| Si/CNT | 1.012 | 1.436 | 0.636 | 0.0014 | 1.539 | 0.024 | 16.8 |
| Si/RT14 | 1.146 | 1.575 | 0.644 | 0.0015 | 1.539 | 0.024 | 15.8 |

### Correlation Between Electrochemical Parameters and Electron/Ion Transport Properties:

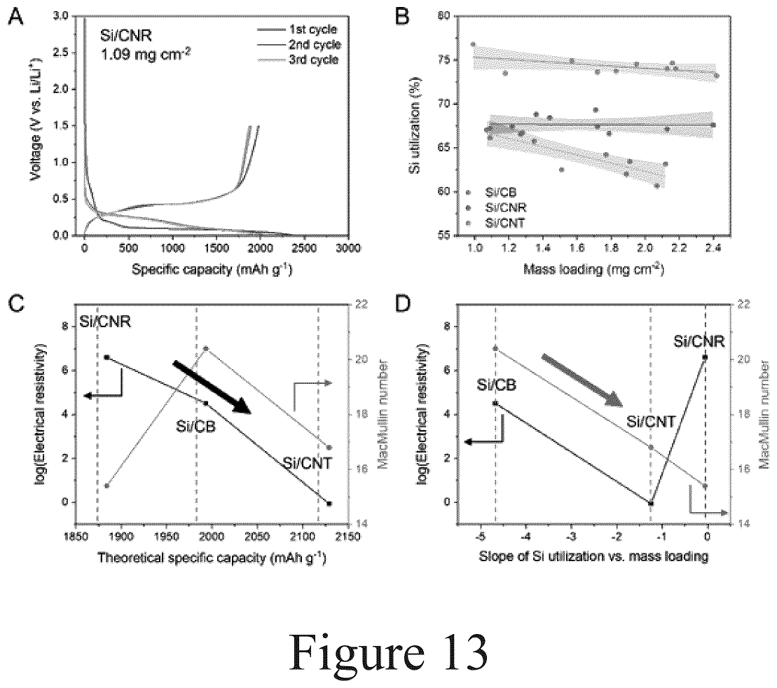

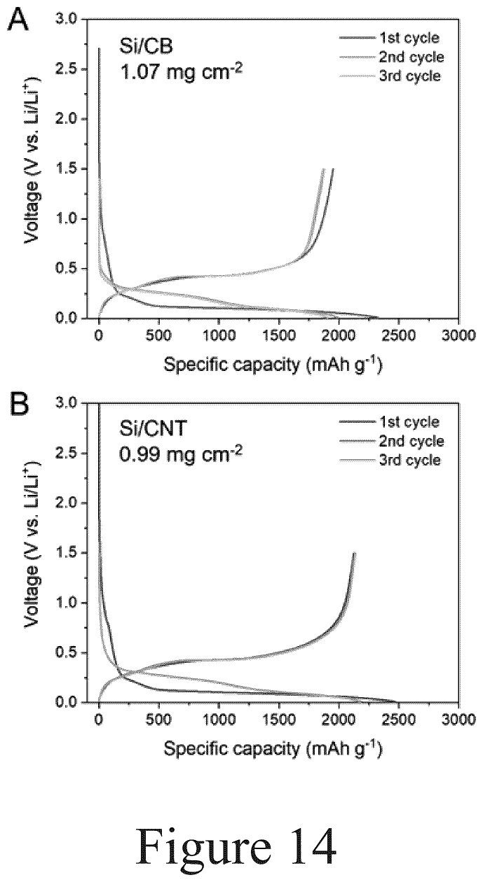

The silicon utilization (defined here as the fraction of silicon that participates in lithium dealloying), was determined by a combination of electronic and ionic transport in the electrode from the active material (Si). To understand how silicon utilization is impacted by these carbons, Si-based electrodes with different thicknesses were prepared and assembled into half cells with GenF electrolyte and three cycles at C/20 were performed. Voltage profiles of these half cells are shown in Panel A of FIG. 13 and FIG. 14. The first lithiation profile shows a plateau below 0.1 V (vs. Li/Li⁺), corresponding to lithiation of crystalline silicon. After the initial amorphization of silicon, the silicon electrodes maintained relatively consistent lithiation/delithiation voltage profiles for the latter cycles.

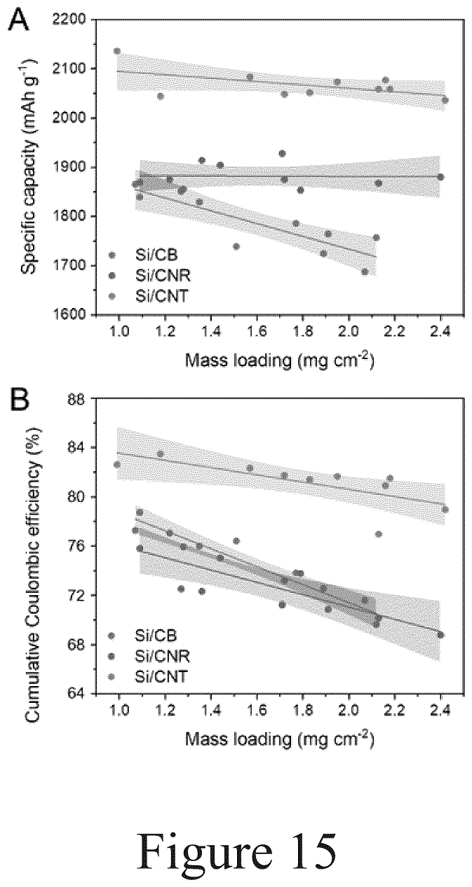

The silicon utilization (determined from the delithiation capacity of the 3rd cycle, see FIG. 15) for all half cells is shown as a function of electrode mass loading in Panel B of FIG. 13 and FIG. 15. When compared to the Si/CB and Si/CNR electrodes, the Si/CNT electrode exhibited higher silicon utilization over the entire mass loading range (see Panel B of FIG. 13 and Panel A of FIG. 15). The theoretical specific capacity of the three electrodes was estimated by the y-intercepts illustrated in Panel A of FIG. 15 when mass loading approaches zero. Panel C of FIG. 13 plots the electrical resistivity and MacMullin number against the theoretical specific capacity. From these data, a clear increase in capacity commensurate with a decrease in average electrical resistivity is evident (see the data represented as black squares, Panel C of FIG. 13). Therefore, one can infer that the electrical connectivity was the limiting factor for lithiating and delithiating the silicon active material under the extreme condition of a very thin electrode where ionic transport is not limiting. Beyond electrical conductivity, the cumulative CE in the first three cycles was used as an indicator of cycling efficiency. The data from the Si/CNT electrodes exhibited the highest cumulative CE for all mass loads compared to the other electrodes (see Panel B of FIG. 15), indicating the lowest irreversible loss during the formation. The improved CE of the CNT/Si electrodes is also consistent with the lower irreversible capacity measured in the CNT-PI electrode (see FIG. 3), suggesting that the carbon additive has a major influence on the early cycle CE for Si/Carbon electrodes.

Si/CNR and Si/CB electrodes delivered similar utilization at low mass loading (1.09 mg cm⁻²), but the Si/CNR electrode maintained its silicon utilization as the electrode thickness increased, whereas the Si/CNT and Si/CB electrodes did not, as indicated by the flat slope of the best-fit line illustrated in Panel B of FIG. 13. Panel D of FIG. 13 plots electrical resistivity and MacMullin number against the slopes derived from the data in Panel B of FIG. 13. The slopes indicate the silicon utilization changed as a function of electrode mass loading. The silicon utilization with increasing mass loading appears to not be dependent on the electrical resistivity as indicated by the non-linear relationship of the data in black squares in Panel D of FIG. 13. This implies that as the electrode becomes thicker, ionic transport is the determining factor for maintaining silicon utilization with increasing thickness. These data provide a clear delineation of electron transport and ion transport on silicon utilization and indicate that one can affect each property by manipulating the carbon nanostructures.

Study on Nanosized Si Electrode with Blended 1D Carbon Nanostructures:

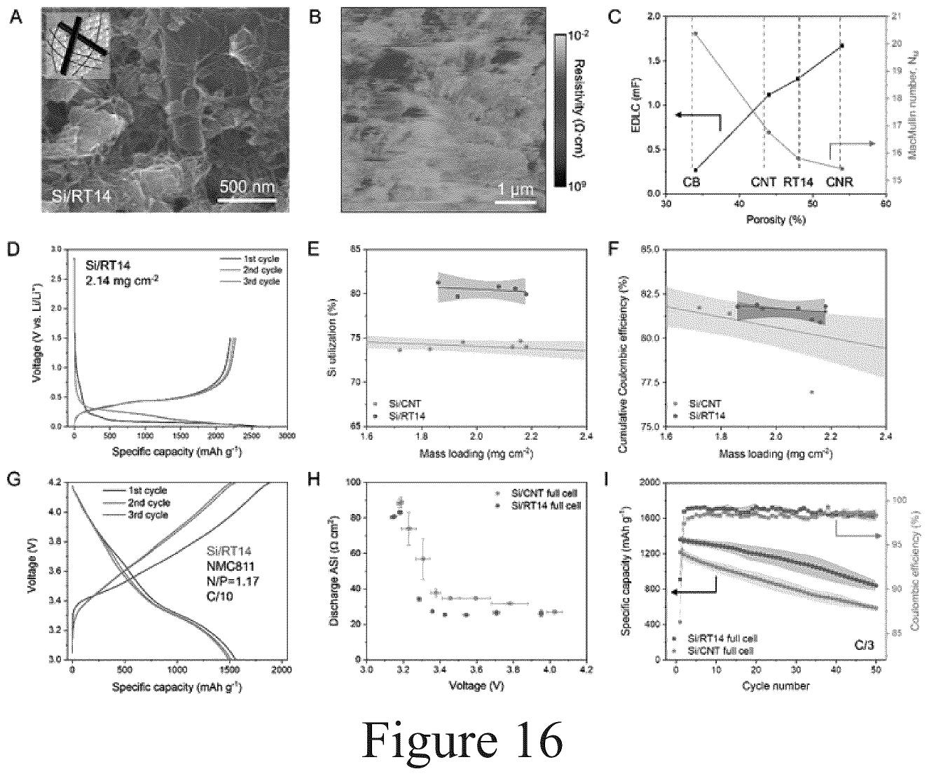

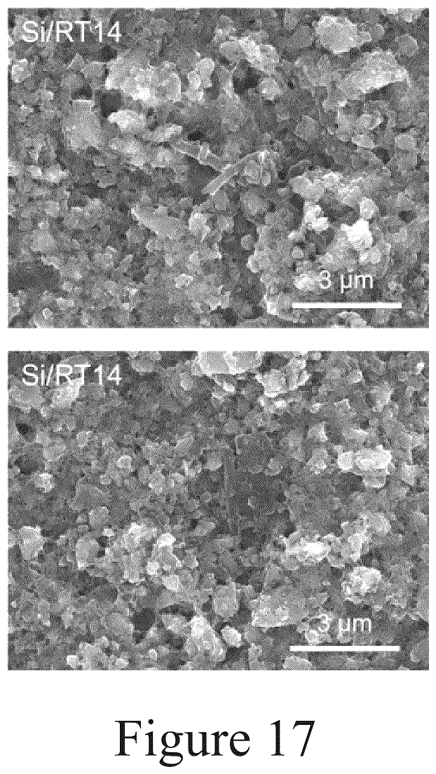

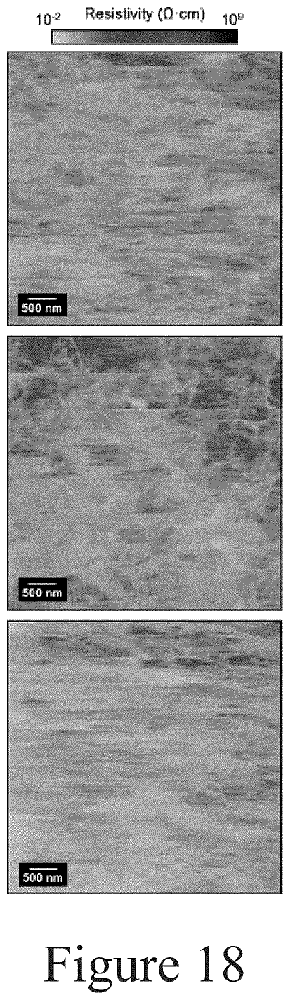

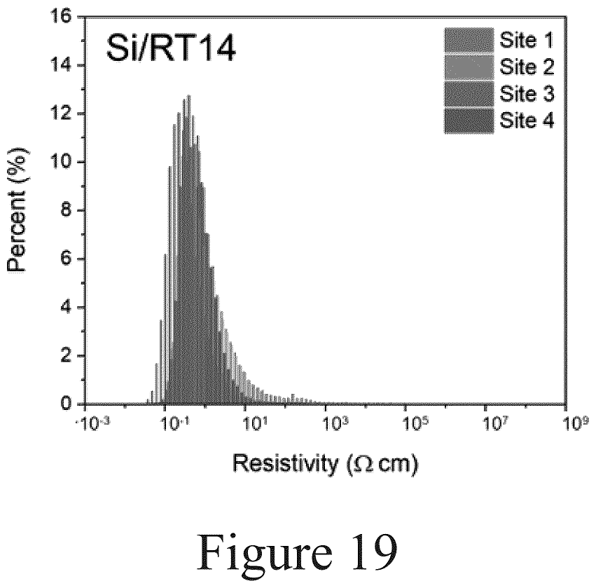

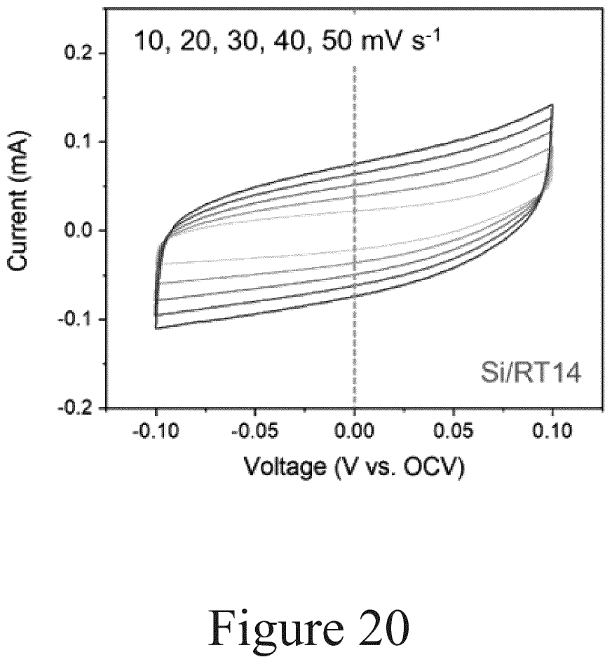

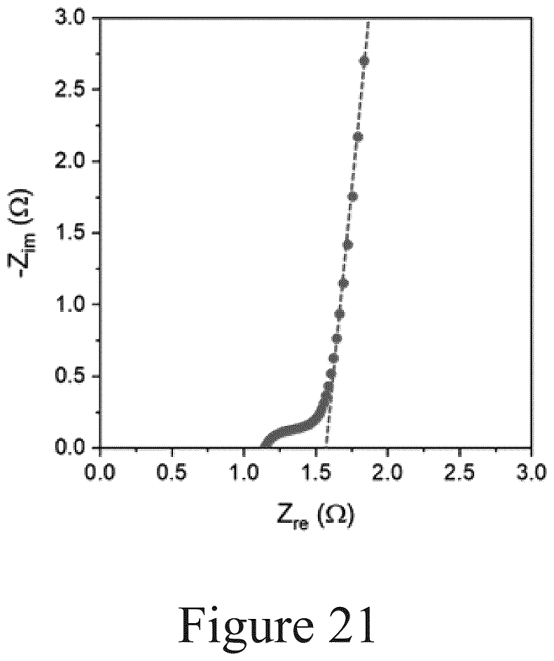

Next, the potential beneficial effects of each carbon in a single electrode were evaluated. To demonstrate the cumulative enhancements provided by CNRs and CNTs, both CNRs and CNTs (in the absence of CB) were incorporated into a single silicon composite electrode in a 1:4 CNR:CNT ratio, denoted as Si/RT14. As shown in the SEM and SSRM images (see Panels A and B of FIG. 16, FIG. 17, and FIG. 18), the Si/RT14 electrode formed an electrically connected network with a narrow distribution of resistivity values and an average value near that of Si/CNT at 7.57×10⁻¹ Ω·cm (see FIG. 18 and FIG. 19). The porosity and the values of N_{M} and EDLC for Si/RT14 fall between those of the Si/CNT electrode and Si/CNR electrode discussed above (see Panel C of FIG. 16, FIG. 20, FIG. 21, and Table 2). Indeed, the electronic and morphological characteristics of this mixed carbon anode capture the benefits of both CNT and CNR to electrical and ionic transport.

TABLE 2
Properties related to ion transport behavior of the nanosized
Si electrodes with different carbon nanostructures.

| | Porosity (%) | EDLC (mF) | N_{M} |
|---|---|---|---|
| Si/CB | 33.6 | 0.267 | 20.4 |
| Si/CNR | 53.8 | 1.670 | 15.4 |
| SI/CNT | 43.4 | 1.117 | 16.8 |
| Si/RT14 | 48.2 | 1.298 | 15.8 |

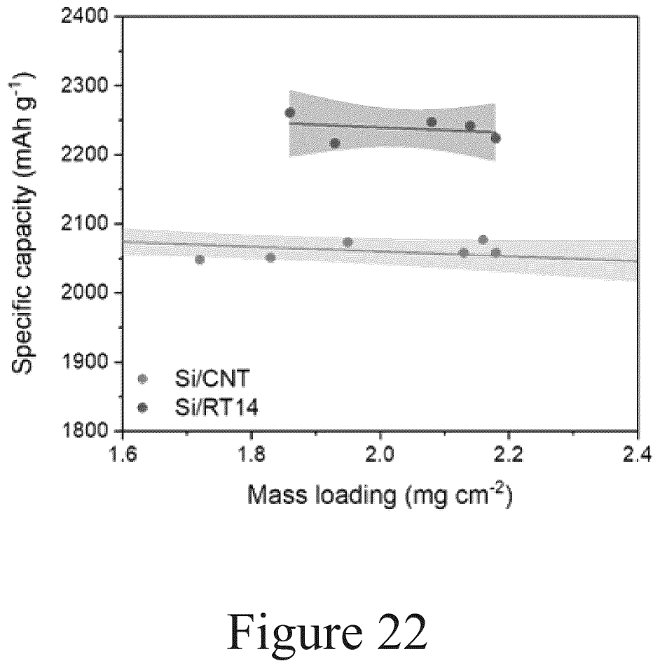

Half-cell electrochemical characterization data are shown in Panels D-F of FIG. 16, and FIG. 22. From Panel D of FIG. 16, the voltage profiles of the Si/RT14 electrode are qualitatively identical to the Si/CNT and Si/CNR electrodes, as expected. However, the specific capacity is greater than either Si/CNT or Si/CNR with a silicon utilization of 81%, which persists with increasingly thick electrodes (see Panel E of FIG. 16). Moreover, the cumulative CE of the Si/RT14 electrode is nearly equal to that of the Si/CNT electrode, if not slightly improved (see Panel F of FIG. 16). These improvements may be attributed to the combination of larger EDLC (1.298 mF)/lower MacMullin number (15.8) from the CNRs and retention of lower electronic resistivity (7.57×10⁻¹ Ω·cm) from the CNTs.

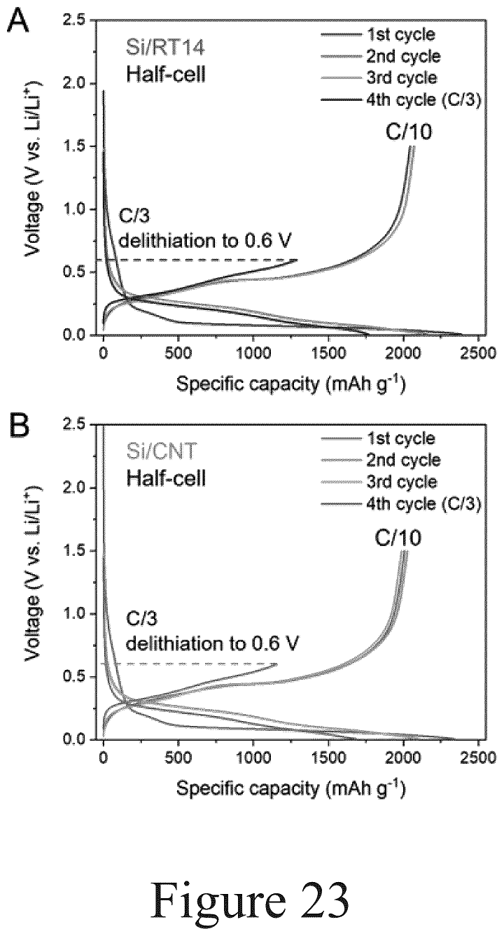

Finally, the performances of the Si/RT14 electrode and the Si/CNT electrode were compared in a capacity-matched full cell against Lithium Nickel Manganese Cobalt Oxide (NMC811). Only the Si/RT14 electrode was compared with the Si/CNT electrode because the Si/CNT electrode has the best cycle performance in a half cell. Before full cell fabrication, the composite anodes were formed and partially pre-lithiated (see FIG. 23) by stopping the final delithiation step in the formation protocol at 0.6 V (vs. Li/Li⁺). This protocol keeps the anodes at a state-of-charge near 30% leaving 70% of the anode capacities for charging and discharging against the NMC811 cathode. The excess electroactive Li compensates for the lost Li⁺ inventory from irreversible processes.

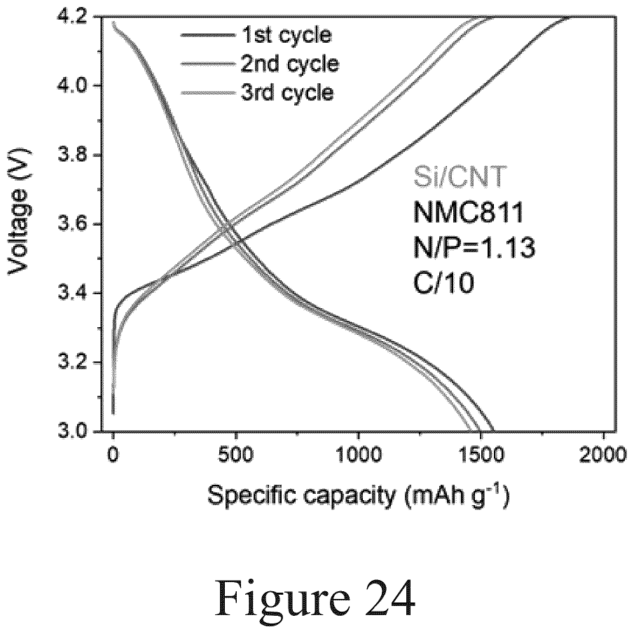

The prelithiated silicon electrodes were assembled into full cells with NMC811 cathodes (4.0 mAh cm⁻²), with an N:P ratio as defined by the ratio of areal capacity between negative electrode (anode), N, and positive electrode (cathode), P, between 1.13 and 1.17. Panel G of FIG. 16 and FIG. 24 display charge/discharge voltage profiles of the Si/RT14 and Si/CNT full cells at C/10 between 3.0 and 4.2 V. At the third cycle at C/10 (where C/10 is defined as the current density charging/discharging the cell to the theoretically predicted capacity for 10 hours), the Si/RT14 full cell delivered a specific discharge capacity of 1536 mAh g⁻¹ based on the silicon electrode mass corresponding to 3.45 mAh cm⁻², while the Si/CNT full cell has 1468 mAh g⁻¹ and 3.28 mAh cm⁻². The increased capacity of the Si/RT14 full cell compared to the Si/CNT full cell is consistent with the data in Panels D-F of FIG. 16, which may be attributed to the CNRs increasing the electrode's ion transport properties.

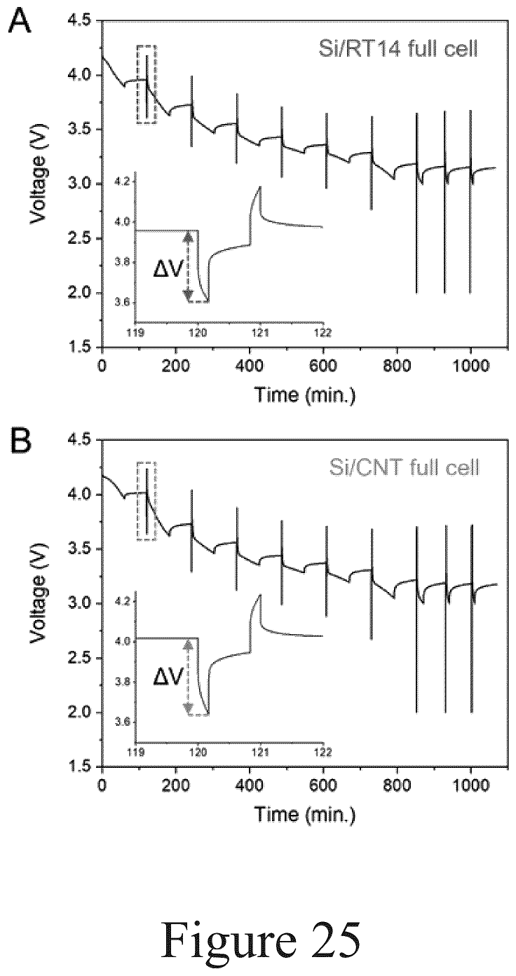

After three cycles at C/10, the full cells were subjected to hybrid pulse power characterization (HPPC) tests to quantify the area specific impedance (ASI) (see FIG. 25). The HPPC measurements reveal a reduction in the ASI over the entire voltage range for Si/RT14 full cell compared to Si/CNT full cell (see Panel H of FIG. 16). As electrical connectivity of both electrodes is similar (8.64×10⁻¹ and 7.57×10⁻¹ Ω·cm for Si/CNT and Si/RT), the lower ASI of the Si/RT14 full cell is likely the result of enhanced ion transport from the presence of CNRs, which is consistent with the data shown in Panel C of FIG. 16.

The full cells were further cycled at C/3 for 50 cycles (see Panel I of FIG. 16). The Si/RT14 full cell provided a higher initial discharge specific capacity of 1360 mAh g⁻¹ (3.05 mAh cm⁻²) than that of the Si/CNT full cell at 1214 mAh g¹ (2.71 mAh cm⁻²). The initial CE of the Si/RT14 full cell was 91.1% and approached 99% on the following cycle. On the other hand, the Si/CNT full cell exhibited a slightly lower initial CE of 86.3%. Consequently, after 50 cycles, the Si/RT14 full cell retained 62% of its discharge specific capacity (839 mAh g⁻¹), while the Si/CNT full cell retained only 48% (585 mAh g⁻¹). The rate of decay after cycle 1, however, seems to be nearly identical for the Si/RT14 and Si/CNT full cells indicating that, despite the Si/CNT full cell displaying a higher CE than the Si/CNR full cell (see Panel B of FIG. 15), the CE in these electrodes is dominated by irreversible losses related to the active material. Nevertheless, the improved capacity in the Si/RT14 full cells compared to the Si/CNT full cells is consistent with the improved ion transport with the addition of CNRs.

In conclusion, these results show that carbonaceous materials can impact both electronic and ionic transport properties in silicon containing composite electrodes. The results presented here highlight the diverse roles of carbonaceous materials in silicon nanoparticle anodes. By leveraging different morphologies of carbonaceous materials, important properties of the anode (Li-ion transport and electrical conductivity) can be impacted without the need for engineering complex silicon nanostructures or using templating agents. Specifically, CNRs increase the electrochemically active surface area and facilitate effective ion conductivity, while CNTs form electrically connected networks in the electrode ensuring robust electron transport. When blended, these two carbon materials, CNRs and CNTs, have a cumulative impact on both electron and ion transport. Consequently, a composite electrode that contains carbonaceous materials with significantly different aspect ratios improves silicon utilization compared to an electrode with only one carbonaceous material. This benefit translates to full cells where silicon utilization is the highest with a blend of carbonaceous materials. Such a realization enables the separation between properties of the composite electrode from properties of the active material which allows for carbon-component optimization rather than active material optimization. Thus, adding different forms of carbonaceous materials into silicon-containing slurries offers a scalable solution to addressing the performance-limiting drawbacks of using nanosized silicon active materials. This structuring strategy provides a scalable pathway for optimizing high loading electrodes using nanosized active material.

### Experimental Procedures:

Materials: Milled boron-doped silicon nanoparticles were prepared at the Oak Ridge National Laboratory by milling boron doped silicon boule (0.001 W-cm—El-Cat) in propylene carbonate. The boron doped silicon was cleaned in successive washes of hot acetone, methanol, 3:1 ratio of NH₄OH:H₂O₂ (reagent grade chemicals Fisher), followed by a 2 minute dip into 5% HF solution prepared with 18 MW deionized water and a final DI water wash before drying in air. The cleaned boule was pulverized into a <10 mesh powder which was loaded in air in a 125 mL stainless steel mill jar with 3/32″ 440 C milling media (Union Process) and propylene carbonate (Aldrich 99.7%) with a ratio of silicon to media to propylene carbonate of 7:5:8. The material was milled in a Retsch eMax mill forming the resulting silicon powder under active cooling to keep the temperature below 50° C. during the milling process. The propylene carbonate was used to passivate the silicon surface and prevent/minimize rejoining of the cleaved silicon during milling. The resultant slurry like material was dried at 250° C. for 2 hours in air to remove excess propylene carbonate. Particle size measurements were performed using NanoBrook 90Plus PALS (Brookhaven Instruments). Samples were prepared by making dispersions of the silicon powder in N-methyl-2-pyrrolidone (NMP). The particle size was obtained using dynamic light scattering (DLS). Each particle size measurement and zeta potential measurement was the average of 100 cycles. Based on this measurement the particle size was 220 nm±10 nm, however the particles appeared as agglomerates in the dry state through electron microscopy. Carbon black (C45, Timcal), multi-walled carbon nanotubes (MWCNTs, 3 wt % in NMP with 1.3 wt % of polyvinylidene fluoride, Cabot Enermax 601), and polyimide binder (Ensiger Tecapowder PI) were utilized, as received without any further treatment. Carbon nanorods (CNRs) were prepared by ball-milling a mixture of phthalic acid (Sigma-Aldrich) and zinc powder (AK Scientific, Inc.), followed by heat treatment at 900° C. for 3 hours in a tube furnace.

Electrode preparation: To prepare the electrodes, carbon nanostructures were pre-dispersed in NMP by bath sonication before addition of other solid components. For carbon-binder electrodes, the carbon-to-binder ratio was 1:1. For the nanosized silicon electrode, lithium acrylate (Gelest, Inc., 1.25 wt % of Si) was introduced into a carbon dispersion in NMP before addition of silicon to stabilize the boron-doped surface. Then, nanosized silicon and PI binder were added to this solution. The final slurry composition ratio for silicon, carbon, and binder was 8:1:1. The slurry was stirred in an Ar-filled glove box overnight and mixed using a dual axis Mazerustar planetary mixer. The slurry was printed on copper foil via doctor blade and then dried at 150° C. for 4 hours. Further thermal curing was carried out at 400° C. for 4 hours. The electrode porosity was assessed based on the known density of the electrode components and the measured electrode volume.

Characterization: SEM images were captured using a Hitachi 4800 microscope with a 15 kV accelerating voltage. SSRM measurements were conducted using a Bruker Dimension Icon AFM with an SSRM module, within an Ar-filled glovebox. SSRM measures the electrical resistivity between a probe and the current collector. The resistivity is the sum of all resistances along the electrical current routes. On a material with high resistivity values, the measured area is mostly localized to the spot of the probe. Measurements on the low resistivity materials, however, sample larger areas. Bruker DDESP-V2 conductive diamond-coated probes were used to collect SSRM data in contact mode, with an applied bias voltage of −0.25 V to the sample while the probe was virtually grounded. Electrochemically active surface area (ECSA) of the electrodes was estimated by measuring cyclic voltammetry (CV) using a Biologic VMP3 potentiostat. CV measurements were performed in a three-electrode cell configuration against stainless steel reference and counter electrode. The voltage range was set to scan from −0.1 to 0.1 V (vs. OCV) and the electrolyte was 0.5 M TBAPF₆ in acetonitrile to avoid lithiation/delithiation during the CV measurements. A symmetric cell was fabricated using two equivalent Si electrodes to measure electrochemical impedance spectroscopy (EIS). EIS was measured using a Biologic VMP3 potentiostat over the frequency range of 0.1-500 kHz at the open circuit voltage with an alternate amplitude of 10 mV. The sloping line in the most magnified Nyquist plot was fitted for x-axis intercept to evaluate Rᵢₒₙ.

Electrochemical measurements: Half cells were assembled against lithium metal in a 2032 coin-type cell. The electrolyte was composed of 1.2 M lithium hexafluorophosphate (LiPF₆) in ethylene carbonate and ethylmethylcarbonate (3:7 w/w) with 3 wt % fluoroethylenecarbonate (FEC), purchased from Tomiyama, and the separator was Celgard® 2325. The half cells were cycled between 1.5 and 0.01 V (vs. Li/Li⁺) and C rates were calculated based on the assumed experimental capacity considering both silicon (3500 mAh g¹) and carbon (100 mAh g⁻¹). Specific capacity was calculated based on the electrode mass. For the full cell assembly, the silicon electrodes were partially prelithiated after three formation cycles at C/10 and collected by disassembling the half cell. The partially prelithiated silicon electrodes were assembled into full cell against the lithium nickel manganese cobalt oxide (NMC811) cathodes, which were provided by the CAMP facility at Argonne National Laboratory. The full cells were cycled between 3.0 and 4.2 V and C rates were calculated based on the 3rd delithiation capacity of the Si electrode half cell. The hybrid pulse power characterization (HPPC) technique was performed to evaluate the area specific impedance (ASI) as a function of depth of discharge, measured at 10% intervals. The procedure pulsed the current in discharge for 10 seconds, followed by a pause to allow the voltage to relax. The current pulsed in charge is 75% of the discharge in the next step. The discharge ASI is determined by dividing the discharge pulse voltage by the applied current.

### EXAMPLES

Example 1. A mixture comprising: a porosity between 15% and 75% empty volume; a plurality of silicon particles; at least one of a first carbonaceous material, a second carbonaceous material, a third carbonaceous material, or a combination thereof, wherein: the first carbonaceous material has a first aspect ratio (AR₁) where ˜1≤AR₁<2; the second carbonaceous material has a second aspect ratio (AR₂) where 2≤AR₂<100; the third carbonaceous material has a third aspect ratio (AR₃) where AR₃≥100; and the silicon particles are present in the mixture at a first concentration between 1 wt % and 50 wt %.

Example 2. The mixture of Example 1, wherein the second carbonaceous and the third carbonaceous are present at a first weight ratio between 1:20 and 20:11.

Example 3. The mixture of either Example 1 or Example 2, wherein the first carbonaceous material comprises at least one of carbon black, carbon nanoparticles, or a combination thereof.

Example 4. The mixture of any one of Examples 1-3, wherein the second carbonaceous material comprises at least one of a carbon nanorod, a carbon nanofiber, or a combination thereof.

Example 5. The mixture of any one of Examples 1-4, wherein the third carbonaceous material comprises at least one of a single-walled carbon nanotube, a multi-walled carbon nanotube, a branched carbon nanotube, or a combination thereof.

Example 6. The mixture of any one of Examples 1-5, further comprising a binder.

Example 7. The mixture of any one of Examples 1-6, wherein the binder comprises at least one of polyimide, polyvinylidene fluoride, polyacrylic acid, carboxymethyl cellulose, or a combination thereof.

Example 8. The mixture of any one of Examples 1-7, wherein the binder is present in the mixture at a second concentration between 0.01 wt % and 20 wt % or between 1 wt % and 15 wt %, and

Example 9. The mixture of any one of Examples 1-8, wherein the silicon is present in the mixture at a mass loading between 0.1 mg Si/cm² and 100 mg Si/cm², or between 1 mg Si/cm² and 10 mg Si/cm², or between 1 mg Si/cm² and 5 mg Si/cm², inclusively.

Example 10. The mixture of any one of Examples 1-9, wherein the silicon particles have an average particle size between 1 nm and 1 μm or between 3 nm and 150 nm.

Example 11. The mixture of any one of Examples 1-10, wherein the silicon particles further comprise an additional element.

Example 12. The mixture of any one of Examples 1-11, wherein the additional element comprises boron.

Example 13. The mixture of any one of Examples 1-12, wherein the first carbonaceous material has an average diameter between 10 nm and 2 μm or between 30 and 100 nm.

Example 14. The mixture of any one of Examples 1-13, wherein the first carbonaceous material is substantially spherical in shape.

Example 15. The mixture of any one of Examples 1-14, wherein the second carbonaceous material has an average width between 10 nm and 500 nm or between 50 nm and 200 nm.

Example 16. The mixture of any one of Examples 1-15, wherein the third carbonaceous material has an average width between 1 nm and 100 nm or between 10 nm and 50 nm and length between 10 nm and 10 μm or between 100 nm and 1 μm.

Example 17. The mixture of any one of Examples 1-16, wherein: the porosity comprises at least one of macropores, mesopores, or micropores, the macropores comprise pores having an average diameter greater than 50 nm, the mesopores comprise pores having an average diameter between 2 nm and 50 nm, inclusively, and the micropores comprise pores having an average diameter less than 2 nm.

Example 18. The mixture of any one of Examples 1-17, wherein the macropores comprise between 0 vol % and 100 vol % or between or between 15 vol % and 60 vol % of the porosity.

Example 19. The mixture of any one of Examples 1-18, wherein the mesopores comprise between 0 vol % and 100 vol % or between or between 15 vol % and 60 vol % of the porosity.

Example 20. The mixture of any one of Examples 1-19, wherein the micropores comprise between 0 vol % and 100 vol % or between or between 15 vol % and 60 vol % of the porosity.

Example 21. The mixture of any one of Examples 1-20, further comprising a silicon utilization between greater than 0% and 100%, or between 25% and 99%, or between 60% and 80%, inclusively.

Example 22. The mixture of any one of Examples 1-21, further comprising a MacMullan number between 1 and 50 or between 1.5 and 20.

Example 23. The mixture of any one of Examples 1-22, further comprising an electrical resistivity between 1×10⁻⁴ Ωcm and 1×10⁹ Ωcm or between 1×10⁻² Ωcm and 1×10⁴ Ωcm.

Example 24. An electrode comprising: a mixture comprising: a plurality of silicon particles; at least one of a first carbonaceous material, a second carbonaceous material, a third carbonaceous material, or a combination thereof; and a current collector having a surface, wherein: the mixture is positioned in the form of a layer on the surface.

Example 25. The electrode of Example 24, wherein the current collector is constructed of a metal.

Example 26. The electrode of either Example 24 or Example 25, wherein the metal comprises at least one of copper, silver, gold, titanium, nickel or aluminum.

Example 27. The electrode of any one of Examples 24-26, wherein the layer of the mixture has a thickness between 1 nm and 0.5 mm or between 1 μm and 100 μm.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A mixture comprising:
a porosity between 15% and 75% empty volume;
a plurality of silicon particles; and
at least one of a first carbonaceous material, a second carbonaceous material, and a third carbonaceous material, wherein:
the first carbonaceous material has a first aspect ratio (AR₁) where ˜1≤AR₁≤2,
the second carbonaceous material has a second aspect ratio (AR₂) where 2≤AR₂<100,
the third carbonaceous material has a third aspect ratio (AR₃) where AR₃≥100, and
the silicon particles are present in the mixture at a first concentration between 1 wt % and 50 wt %.

2. The mixture of claim 1, wherein the second carbonaceous and the third carbonaceous are present at a first weight ratio between 1:20 and 20:11.

3. The mixture of claim 1, wherein the second carbonaceous material comprises at least one of a carbon nanorod, a carbon nanofiber, or a combination thereof.

4. The mixture of claim 1, wherein the third carbonaceous material comprises at least one of a single-walled carbon nanotube, a multi-walled carbon nanotube, a branched carbon nanotube, or a combination thereof.

5. The mixture of claim 1, further comprising a binder.

6. The mixture of claim 1, wherein the binder comprises at least one of polyimide, polyvinylidene fluoride, polyacrylic acid, carboxymethyl cellulose, or a combination thereof.

7. The mixture of claim 5, wherein the binder is present in the mixture at a second concentration between 0.01 wt % and 20 wt %.

8. The mixture of claim 1, wherein the silicon is present in the mixture at a mass loading between 0.1 mg Si/cm² and 100 mg Si/cm².

9. The mixture of claim 1, wherein the silicon particles have an average particle size between 1 nm and 1 μm.

10. The mixture of claim 1, wherein the first carbonaceous material has an average diameter between 10 nm and 2 μm.

11. The mixture of claim 1, wherein the first carbonaceous material is substantially spherical in shape.

12. The mixture of claim 1, wherein the second carbonaceous material has an average width between 10 nm and 500 nm.

13. The mixture of claim 1, wherein the third carbonaceous material has an average width between 1 nm and 100 nm.

14. The mixture of claim 1, wherein:
the porosity comprises at least one of macropores, mesopores, or micropores,
the macropores comprise pores having an average diameter greater than 50 nm,
the mesopores comprise pores having an average diameter between 2 nm and 50 nm, inclusively, and
the micropores comprise pores having an average diameter less than 2 nm.

15. The mixture of claim 14, wherein the macropores comprise between 0 vol % and 100 vol %.

16. The mixture of claim 14, wherein the mesopores comprise between 0 vol % and 100 vol %.

17. The mixture of claim 14, wherein the micropores comprise between 0 vol % and 100 vol %.

18. The mixture of claim 14, further comprising a MacMullan number between 1 and 50.

19. The mixture of claim 14, further comprising an electrical resistivity between 1×10⁴ Ωcm and 1×10⁹ Ωcm.

20. An electrode comprising:
a mixture comprising:
a plurality of silicon particles; and
at least one of a first carbonaceous material, a second carbonaceous material, a third carbonaceous material, or a combination thereof; and
a current collector having a surface, wherein:
the mixture is positioned in the form of a layer on the surface.
